(19) United States
(12) Patent Application Publication
(10) Pub. No.: US 2017/0140853 A1
(43) Pub. Date: May 18, 2017

(54) Method for Producing a Surge Arrester, Apparatus for Carrying out the Method, and Surge Arrester Produced in Accordance with the Method

(71) Applicant: Tridelta Meidensha GMBH, Hermsdorf (DE)

(72) Inventors: Torsten Hölzer, Jena (DE); Karsten Laue, Weissenborn (DE); Stephan Hilmer, Bad Klosterlausnitz (DE)

(21) Appl. No.: 15/207,615

(22) Filed: Jul. 12, 2016

(30) Foreign Application Priority Data
Jul. 13, 2015 (DE) 102015009045.3

(51) Int. Cl. H01C 7/12; B29C 45/14; H01C 1/02; B29B 7/84; H01C 17/30; B29C 45/00; B29C 45/17

(52) U.S. Cl. CPC H01C 7/12; B29C 45/0001; B29C 45/0025; B29C 45/14065; B29C 45/14819; B29C 45/14778; B29C 45/14639; B29C 45/1701; B29B 7/84; H01C 17/30; H01C 1/02; B29K 2905/02; B29K 2709/08

(57) ABSTRACT

The invention relates to a method for producing a surge arrester, comprising the steps of:
providing a module 1 comprising one or more varistor blocks 3 and two end armatures 5;
introducing the module 1 into a mould 7 in order to form a housing 21;
evacuating the mould 7 in a vacuum chamber 9;
introducing liquid silicone 11 into the evacuated mould 7 in the vacuum chamber 9;
baking the mould 7 in order to crosslink the silicone 11; and
removing the surge arrester from the mould 7.

The invention relates to a method for producing a surge arrester, to an apparatus for carrying out the method, and to a surge arrester which is produced in accordance with the method.

DE 10 2007 056 111 A1 discloses a method for producing surge arresters having a silicone outer housing. According to this method, a module having a stack comprising two end armatures and at least one arrester block/varistor block is formed. A plurality of glass fibre-reinforced plastic rods are fastened to the end armatures and hold the one or the several varistor blocks between the two end armatures. The module which is produced in this way is introduced into a mould or a casting mould, and the mould is filled with liquid silicone under high pressure. The mould has a heating device through which, for example, hot water or warm oil can flow (or is electrically heated), so that the silicone in the mould is crosslinked.

In this production method, it is necessary to fill the mould with silicone at high pressure in order to completely displace all of the air left in the mould. To this end, it is furthermore necessary for the mould to be held closed with a great deal of force, this requiring a corresponding complex closing apparatus.

The mould also has to be able to withstand the high pressures. Therefore, moulds of this kind are usually manufactured from steel.

Owing to this construction, the mould is very heavy. It is not possible to remove the mould from the closing apparatus in order to already begin producing the next surge arrester with the same mixing device for the silicone and the same closing apparatus using another mould while the silicone is baking.

A further disadvantage of the known method is that refitting a mould in the closing apparatus or changing a mould for another purge arrester is complicated.

Although the abovementioned document discloses that the mould can be of modular design, so that surge arresters of different lengths can be produced, refitting the modular mould is also associated with a considerable amount of expenditure, and therefore long downtimes and high costs arise during production.

It has also been found that the air which is released in the silicone contributes to a very high pressure increase in the mould during the crosslinking process.

DE 10 2009 051 155 A1 discloses surrounding a hollow insulator with a silicone housing, wherein the silicone is degassed before being introduced into a mould in order to form the housing. To this end, the storage container for the silicone is evacuated. Steel, which can withstand the high closing forces, is used for the mould here too. The mould is provided with ventilation bridges in order to prevent gas pockets and in order to allow the silicone housing to be formed without so-called “flash”, that is to say without silicone entering the intermediate spaces in the mould, and without unnecessary parts (webs) having to be removed from the insulator housing by hand after the insulator is complete.

The object of the invention is to provide a method for producing a surge arrester, an apparatus for carrying out the method, and a surge arrester which is produced in accordance with the method, said method, apparatus and surge arrester allowing the surge arrester to be produced in a simpler and more cost-effective manner.

The object is achieved by a method according to claim 1, an apparatus according to claim 8, and a surge arrester according to claim 9.

According to a first aspect of the invention, the method for producing a surge arrester comprises the steps of: providing a module comprising one or more varistor blocks and two connection terminals or end armatures, introducing the module into a mould in order to form a housing, evacuating the mould in a vacuum chamber, introducing liquid silicone into the evacuated mould in the vacuum chamber, baking the mould in order to cross link the silicone, and removing the surge arrester from the mould.

According to a further aspect of the invention, the method additionally comprises the step of the mould, after being filled with the liquid silicone, being removed from the vacuum chamber and introduced into a furnace for the baking step.

The silicone is further preferably introduced into the mould substantially at zero pressure in the method.

According to a further advantageous aspect of the invention, the silicone is degassed before being introduced into the mould.

It is also preferred for the module to have a plurality of glass fibre-reinforced plastic rods which hold the one or the several varistor blocks between the end armatures.

According to the invention, the pressure in the vacuum chamber is less than 250 mbar, preferably less than 10 mbar, particularly preferably less than 5 mbar, when the silicone is introduced into the mould.

The method of the invention allows the mould to be manufactured from aluminium and to be held closed using simple screws or a clamping lever.

The method according to the invention is preferably carried out in an apparatus which comprises: a vacuum chamber for accommodating the mould, a mixing device for mixing and supplying the silicone, a vacuum pump for degassing the silicone and a vacuum pump for applying a negative pressure to the vacuum chamber, a pump for conveying the silicone to the mould, and a furnace for baking the silicone in the mould after the said mould is filled with the liquid silicone.

Finally, according to the invention, a surge arrester is produced in accordance with the method according to the invention, the said surge arrester having: a module comprising one or more varistor blocks and two end armatures, wherein the varistor blocks are held between the end armatures by glass fibre-reinforced plastic rods, and a housing which is composed of silicone which has been degassed and has been introduced into a mould in a vacuum environment.

The invention will be described below with reference to preferred exemplary embodiments and the appended figures, in which:

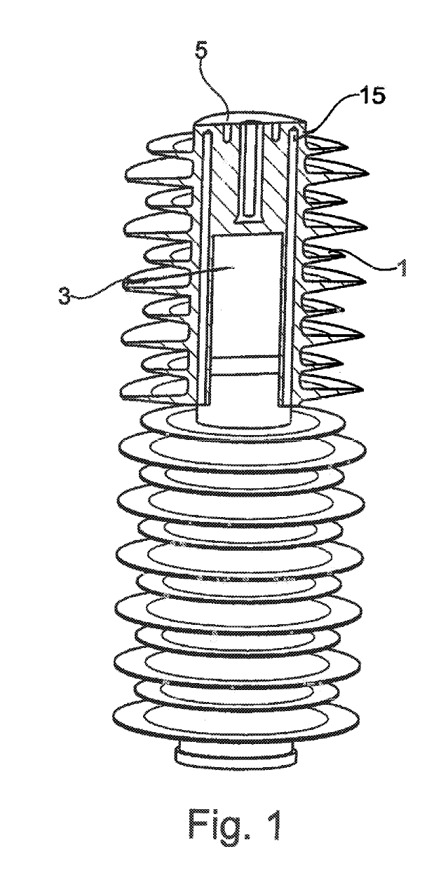

FIG. 1: shows a flowchart for illustrating the method according to the invention;

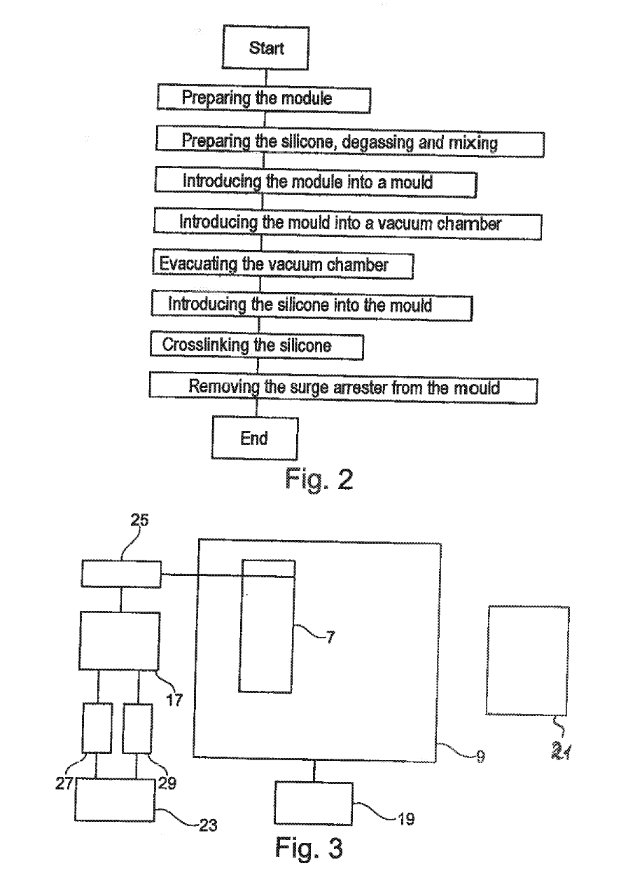

FIG. 2: shows a drawing of a vertical section through a surge arrester which is produced in accordance with the method according to the invention; and

FIG. 3: shows an apparatus for carrying out the method according to the invention.

FIG. 1 shows a method according to the invention for producing a surge arrester with reference to a flowchart.

A module 1, which is shown in FIG. 2, comprising a stack of a plurality of varistor blocks 3, which are held between two end armatures 5 by means of a plurality of glass fibre-reinforced plastic rods 15, is prepared in a first step.

The glass fibre-reinforced plastic rods 15 are held in holes or bores in the end armatures 5. This can be executed by means of wedge connections or by means of crimping or using other known techniques. A cage comprising glass fibre-reinforced plastic rods 15, in which cage the varistor blocks 3 are accommodated, is formed in this way.

Spring elements and spacer elements, not shown, are usually also contained in the module 1, so that the varistor blocks 3 are held between the end armatures 5 under mechanical stress.

The material for the outer housing, specifically liquid silicone or LSR (liquid silicone rubber), is prepared in a second step. Typical constituent parts are linear siloxanes: approximately 70%, filler: approximately 30%, and additive: approximately 1%. In general, a large number of types of LSR material of different hardness will be available.

One example of a silicone which can be used according to the invention is POWERSIL® XLR® 630 from Wacker.

To this end, a two-component silicone of low viscosity and high-temperature vulcanization is usually provided in ready-to-use bundle units. The components and possible additives, including for colouring, are mixed using a multi-component mixing and metering system as the mixing device.

According to the invention, the mixture is degassed, wherein the sub-components have preferably already been degassed before they are mixed.

In order to reduce the process time, the mixture can also be preheated.

in a third step, the module 1 is introduced into a suitable mould 7 which is designed to form the silicone outer housing. Surge arresters usually have a plurality of shields which surround a circular-cylindrical core. The shields, which can have different diameters if required, serve to increase the size of the creepage distance and prevent continuous water paths forming between the connections.

The mould 7 can be a simple aluminium mould, In contrast to the prior art, it is not necessary for the mould 7 to allow a high closing pressure in case of the invention. The invention permits the use of lightweight and low-cost moulds, this being helpful particularly when producing surge arresters with a large number of different lengths, diameters and shield shapes.

In a next step, the mould 7 with the module 1 contained therein is introduced into a vacuum chamber 9. An inlet opening, or a plurality of inlet openings, in the mould 7 in the vacuum chamber 9 are connected to corresponding supply lines for the liquid silicone.

In a further step, the vacuum chamber 9 and therefore the mould 7 which is accommodated in the said vacuum chamber are evacuated. The pressure in the interior of the vacuum chamber 9, and therefore also in the interior of the mould 7, is preferably 250 mbar or less, preferably 10 mbar or less, and particularly preferably 5 mbar or less.

It is now possible for the silicone to flow into the mould 7. To this end, suitable shut-off valves in the supply lines are opened and the silicone is conveyed from the storage container into the mould in the vacuum chamber by means of a pump.

Since the mould is evacuated, no gas pockets or bubbles which have to be pressed out at high pressure form In the dead corners either.

After the mould 7 is filled, the mould, with the module contained therein and the liquid silicone which forms the housing, is removed from the vacuum chamber, the said vacuum chamber being vented for this purpose. The mould is introduced into a furnace, and the liquid silicone vulcanizes completely at appropriate temperatures for approximately 20 minutes. Temperatures of the furnace are preferably 130° C. or less, further preferably 80° C. or less, particularly preferably in the region of 70° C.

After curing or crosslinking, the mould is opened, and the finished surge arrester can be removed. The silicone housing which is produced in this way surrounds the module 1 and provides protection against environmental influences. Strong forces which would make a high closing force necessary do not occur either when the silicone is introduced into the mould or during subsequent crosslinking. The important factor is essentially that both the liquid silicone used and the mould have been degassed or evacuated before the mould is filled with the liquid silicone, so that there are no gas or air pockets, which would lead to corresponding pressure increases, in the silicone. Since the mould is not filled with silicone at high pressure either, no “flash”, that is to say thin “webs”, forms at the seams of the mould. This saves the said webs from having to be removed again after the surge arrester is complete and also saves on the relatively high-cost material for production.

FIG. 3 once again shows, in detail, the apparatus for executing the method according to the invention. In the preferred embodiment, two vacuum pumps 19 and 23 are used for the mixing device 17 of the silicone on the one hand and the vacuum chamber 9 on the other hand. However, this is not absolutely necessary, and it is feasible for the same vacuum pump to be used for both purposes.

The vacuum chamber 9 has a large door or gate which can be closed and through which the mould 7 together with the module 1 contained therein can be introduced into the vacuum chamber 9, and through which the mould 7 can also be removed again after it has been filled with the silicone. Supply lines for the liquid silicone are provided in the vacuum chamber 9 itself, it being possible to connect the said supply lines to the mould 7, so that the liquid silicone can flow into the mould 7 through corresponding inlet openings. The shown mixing device for the silicone is designed in such a way that the silicone components can be degassed during stirring in the storage containers. This makes it easier to remove the residual air. The degassed silicone is subsequently mixed and then pumped into the mould 7. This can be done by a dedicated pump 23 being provided between the mixing device and the mould.

One advantage of the invention is that, after a first mould 7 containing a surge arrester surrounded by silicone which has not yet been crosslinked has been removed, a second mould with the module 1 contained therein can equally be introduced into the vacuum chamber 9, so that the said vacuum chamber can be operated with several moulds in parallel, said moulds then being introduced into a furnace 21 either together or one after the other. It is also possible for several moulds to be introduced into the vacuum chamber at the same time, the said moulds then being filled one after the other and subsequently being removed from the vacuum chamber together.

According to the invention, the internal pressure of the mould can be kept low. The mould 7 itself can be designed to be smaller and more lightweight than in the prior art.

Large and heavy closing machines are not required. Furthermore, the moulds 7 can be produced in a lightweight and substantially smaller and therefore cost-effective manner from aluminium.

Different moulds can be filled with silicone one after the other or at the same time in the same vacuum chamber 9, as a result of which different types of surge arrester with different diameters, different lengths or different shield geometries can be produced. Therefore, it is also possible to meet special customer requests.

The method according to the invention furthermore allows the tool costs to be reduced to such an extent that small series can be produced in an economical manner.

Finally, casting of the silicone housing in the vacuum chamber 9 is also advantageous in as much as the risk of air bubbles in the cast surge arrester is considerably reduced. The method leads to less waste, less subsequent work and to a better quality.

1. Method for producing a surge arrester, comprising the steps of:
providing a module (1) comprising one or more varistor blocks (3) and two end armatures (5);
introducing the module (1) into a mould (7) in order to form a housing (21);
evacuating the mould (7) in a vacuum chamber (9);
introducing liquid silicone (11) into the evacuated mould (7) in the vacuum chamber (9);
baking the mould (7) in order to crosslink the silicone (11); and
removing the surge arrester from the mould (7).

2. Method according to claim 1, in which the mould, after being filled with the liquid silicone (11), is removed from the vacuum chamber (9) and introduced into a furnace (13) for the baking step.

3. Method according to claim 1, in which the silicone is introduced into the mould (7) substantially at zero pressure.

4. Method according to claim 1, in which the silicone is degassed before being introduced into the mould (7).

5. Method according to claim 1, in which the module has a plurality of glass fibre-reinforced plastic rods (15) which hold the one or the several varistor blocks (3) between the end armatures (5).

6. Method according to claim 1, in which the pressure in the vacuum chamber (9) is 250 mbar or less, preferably 1.0 mbar or less, particularly preferably 5 mbar or less, when the silicone is introduced into the mould (7).

7. Method according to claim 1, in which the mould (7) is manufactured from aluminum.

8. Apparatus for carrying out the method according to claim 1, wherein the apparatus comprises:
a vacuum chamber (9) for accommodating the mould (7);
a mixing device (17) for mixing and supplying the silicone;
a vacuum pump (19) for degassing the silicone;
a vacuum pump (23) for applying a negative pressure to the vacuum chamber (9);
a pump (25) for supplying the silicone from a storage container to the mould (7) in the vacuum chamber (9); and
a furnace (21) for baking the silicone in the mould (7) after the said mould is filled with the silicone.

9. Surge arrester which is produced in accordance with a method according to claim 1, wherein the surge arrester has:
a module (1) comprising one or more varistor blocks (3) and two end armatures (5), wherein the varistor blocks (3) are held between the end armatures (5) by glass fibre-reinforced plastic rods (15); and
a housing (21) which is composed of silicone which has been degassed and cast at zero pressure.

10. Apparatus for producing a surge arrestor, wherein the apparatus comprises:
a vacuum chamber (9) for accommodating the mould (7);
a mixing device (17) for mixing and supplying the silicone;
a vacuum pump (19) for degassing the silicone;
a vacuum pump (23) for applying a negative pressure to the vacuum chamber (9);
a pump (25) for supplying the silicone from a storage container to the mould (7) in the vacuum chamber (9); and
a furnace (21) for baking the silicone in the mould (7) after the said mould is filled with the liquid silicone.

11. A surge arrester comprising:
a module (1) comprising one or more varistor blocks (3) and two end armatures (5), wherein the varistor blocks (3) are held between the end armatures (5) by glass fibre-reinforced plastic rods (15); and
a housing (21) which is composed of silicone which has been degassed and cast at zero pressure.

12. Method according to claim 2, in which the silicone is introduced into the mould (7) substantially at zero pressure.

13. Method according to claim 3 in which the silicone is degassed before being introduced into the mould (7).

14. Method according to claim 4, in which the module has a plurality of glass fibre-reinforced plastic rods (15) which hold the one or the several varistor blocks (3) between the end armatures (5).

15. Method according to claim 5, in which the pressure in the vacuum chamber (9) is 250 mbar or less, preferably 10 mbar or less, particularly preferably 5 mbar or less, when the silicone is introduced into the mould (7).

16. Method according to claim 6, in which the mould (7) is manufactured from aluminum.
